(19) United States
(12) Patent Application Publication
(10) Pub. No.: US 2010/0156118 A1
(43) Pub. Date: Jun. 24, 2010

(54) CAP FOR FUEL TANKS, IN PARTICULAR FOR MOTOR CYCLES

(75) Inventors: Marco CODELUPPI, Carpi (IT); Lorenzo IOTTI, Bagnolo in Piano (IT)

Correspondence Address: Pearne & Gordon LLP, 1801 East 9th Street, Suite 1200, Cleveland, OH, 44114-3108, US

(73) Assignee: ZADI S.P.A., Carpi (Modena) (IT)

(21) Appl. No.: 12/640,470

(22) Filed: Dec. 17, 2009

(30) Foreign Application Priority Data
Dec. 18, 2008 (IT) MO2008A000325

(51) Int. Cl. E05C 3/16

(52) U.S. Cl. 292/52

(57) ABSTRACT

A cap for fuel tanks, in particular for motorcycles, comprising: an annular body, predisposed to be fixed stably on board an access opening of a tank, which access opening delimits a through-opening through which the tank can be accessed; a lid, constrained rotatably to the annular body, which is rotatable between an open position, in which the through-opening can be accessed, and a closed position, in which the through-opening cannot be accessed; a closure device, predisposed to block the lid in the closed position. The closure device comprises: a manoeuvring lever, associated to the lid; a bolt, operatively associated to the manoeuvring lever, by which manoeuvring lever the bolt is activated in motion between a closed position, in which the bolt prevents rotation of the lid from the closed position to the open position, and an open position, in which the bolt allows the rotation of the lid; a blocking and unblocking device, operatively connected to the bolt, predisposed to assume, on command, an enabled configuration, in which the blocking and unblocking device enables the bolt to be arranged in the open position, and a disenabled configuration, in which the blocking and unblocking device prevents the bolt from being arranged in the open position.

### BACKGROUND OF THE INVENTION

The invention relates to a cap for fuel tanks, in particular for motor cycle fuel tanks.

Motor cycles are normally provided with a cap for access to the fuel tank. The cap is provided with a lid for access to the tank, the lid being provided with a lock barrel. The lock barrel enables blocking and unblocking of the fuel-tank cap by introducing and rotating a key, which is normally the same key required for starting up the motor. In this way, the key offers a minimum condition of safety connected to the fact that the key has to be extracted from the ignition block of the motor cycle before opening the tank; this means that the motor must be switched off before the tank is accessed.

The degree of safety offered by the key is in reality rather modest, as the user might easily obtain a second key with which to open the cap cover without having to stop the motor. Further, the key offers no type of safety in dangerous situations which might obtain with the opening of the cap lid, for example when the motor cycle is too inclined, or a condition in which the motor cycle is not stationary. Moreover, the use of the key is in any case awkward, especially when the rider is wearing gloves.

The aim of the present invention is to provide a cap for tanks, in particular for motor cycles, which provides greater safety guarantees with respect to caps of known type and which is further more handy to use.

The set technical task and the set aims are substantially attained by the cap for tanks comprising the technical characteristics as set out in one or more of the accompanying claims.

### BRIEF DESCRIPTION OF THE DRAWINGS

Characteristics and advantages of the present invention will better emerge from the following description of a non-limiting embodiment of the invention, provided by way of non-limiting example in the accompanying figures of the drawings, in which:

FIG. 1 is a view from above of a cap for tanks according to the present invention;

FIG. 2a is a section view of the cap of FIG. 1 according to line II-II of FIG. 1;

FIGS. 2b and 2c show the cap of FIG. 2a in two working configurations;

FIG. 3 is a section view of the cap of FIG. 1 according to line of FIG. 2a;

FIG. 4 is a section view of the cap of FIG. 1 according to line IV-IV of FIG. 2a;

FIGS. 5 and 6 are two axonometric views of a component of the cap of the present invention.

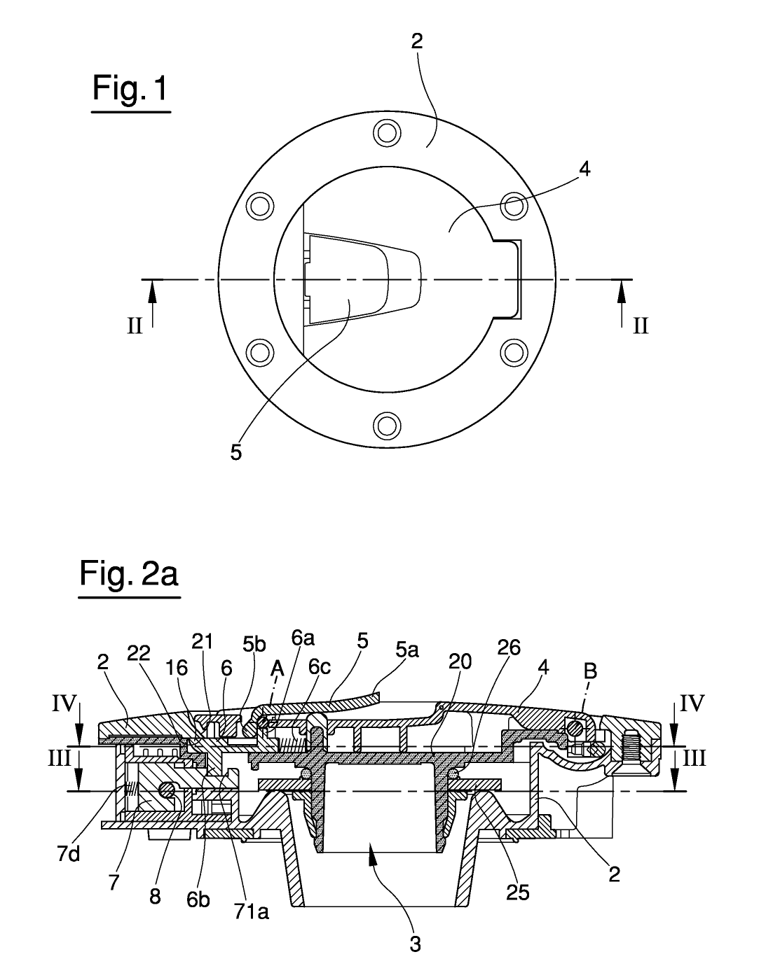

### DESCRIPTION of the PREFERRED EMBODIMENTS

With reference to the accompanying figures, the cap for tanks of the present invention comprises an annular body 2, predisposed to be fixed stably to the edge of an access opening of a tank, which delimits a through-opening 3 through which the tank can be accessed. The annular body 2 is a common component of caps for tanks, in particular for motor cycles, and as such will not be further described in detail.

A lid 4 is rotatably constrained to the annular body 2, which lid 4 is rotatable about an axis B between an open position, in which the through-hole 3 is accessible, and a closed position, in which the through-hole 3 is not accessible.

A shaped element 20, a seal ring 25 and an o-ring 26 are interposed between the annular body 2 and the lid 4, which shaped element 20, seal ring 25 and o-ring 26 have the function of preventing leakage of the liquid contained in the tank.

The cap is provided with a closing device, predisposed to block the lid 4 in the closed position.

The closing device comprises a manoeuvring lever 5, rotatably associated to the lid 4 about a rotation axis A between a closed position and an open position. A bolt 6 is operatively associated to the manoeuvring lever 5 and is activated thereby to move between a closed position, in which it prevents the rotation of the lid 4 from the closed position to the open position, and an open position, in which it enables rotation of the lid 4. In the closed position, the bolt 6 has an end 16 below an undercut of the annular body 2, such that the rotation of the lid 4 is prevented, while in the open position the end 16 of the bolt 6 does not interfere with the undercut of the annular body 2.

The manoeuvring lever 5 comprises a first end 5a, on which a user can act by rotating the manoeuvring lever 5 itself, and a second end 5b, facing downwards, which is predisposed to interact with the bolt 6. To this end the bolt 6 comprises a first appendage 6a, facing upwards and predisposed to interact with the second end 5b of the manoeuvring lever 5. Elastic means 6c, for example a helical spring, are predisposed to push the bolt 6 towards the closed position and to keep the first appendage 6a in constant contact with the second appendage 5b of the manoeuvring lever 5.

The closing device further comprises a blocking and unblocking device, operatively connected to the bolt 6 and predisposed to assume, on command, an enabled configuration in which the bolt 6 can move into the open position, and a disenabled configuration, in which it prevents the bolt 6 from moving into the open position.

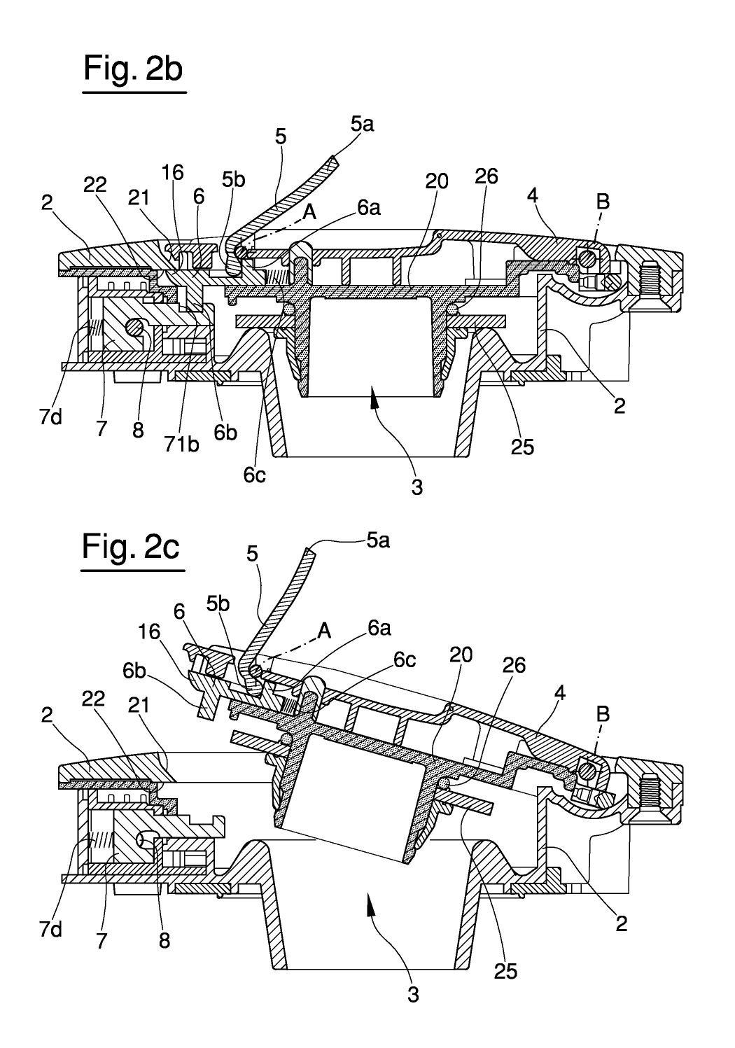

The blocking and unblocking device 7, 8, 9 comprises a cursor 7. The cursor 7 is associated to the block 6 such as not to obstruct a first tract of the bolt 6 run from the closed position into the open position. For this purpose the cursor 7 comprises a first seating 7a, facing upwards, which is predisposed to house a second appendage 6b of the bolt 6 facing downwards. The first seating 7a exhibits an extension along the run of he bolt 6 which substantially corresponds to the first tract of run of the bolt 6 from the closed position to the open position (FIG. 2c). During the first tract of the run of the bolt 6, the second appendage 6b of the bolt 6 slides freely internally of the first seating 7a. At the end of the first tract of run, the second appendage 6b of the bolt 6 is arranged abutting a first abutment 71a of the first seating 7a (FIG. 2b). From this position, for a second tract of the bolt 6 run, the bolt and the cursor 7 are solidly constrained to one another in the sliding direction of the bolt 6 from the closed position into the open position. In this way, if the cursor 7 is free to follow the sliding of the bolt 6, the bolt 6 can reach its open position, while if the cursor 7 is prevented from following the run of the bolt 6, the bolt 6 cannot reach the open position thereof and the cap cannot be opened.

In order to control the cursor's 7 freedom to move, the blocking and unblocking device comprises an anchoring element 8, 9, predisposed to assume an open configuration and a closed configuration. In the open configuration the anchoring element 8, 9 enables the cursor 7 to follow the bolt 6 in the second tract of run from the closed position to the open position. In the closed configuration, the anchoring element prevents the cursor 7 from following the bolt 6 in the second tract of run from the closed position to the open position, such that the bolt 6 cannot reach the open position.

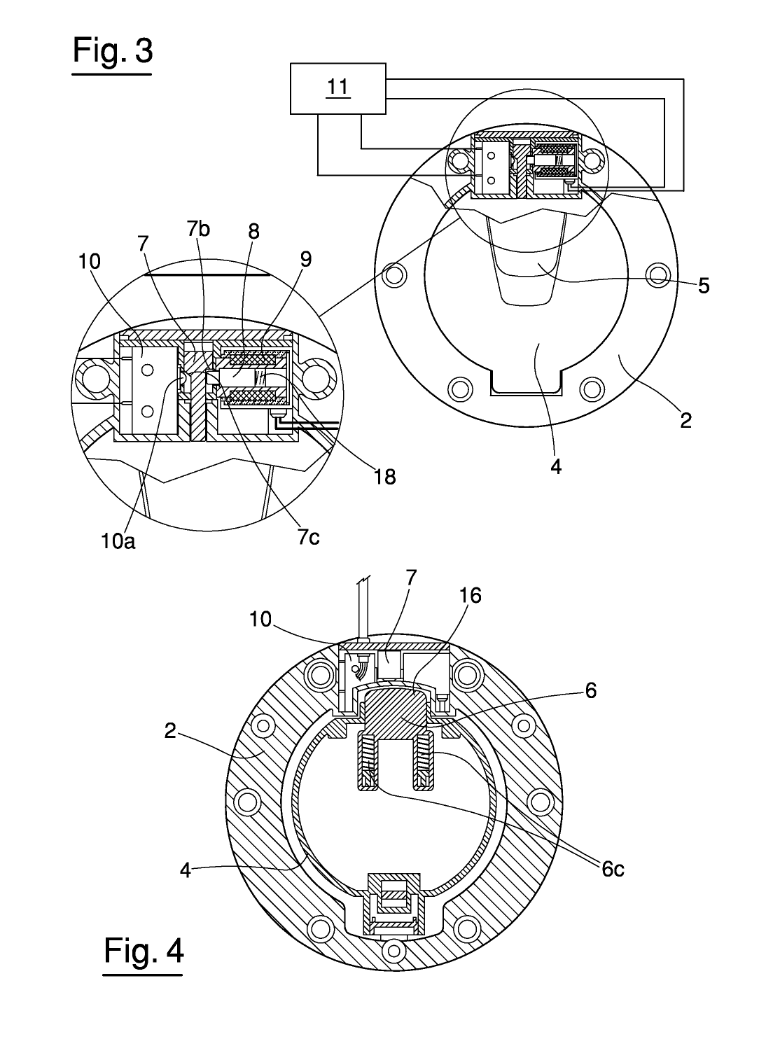

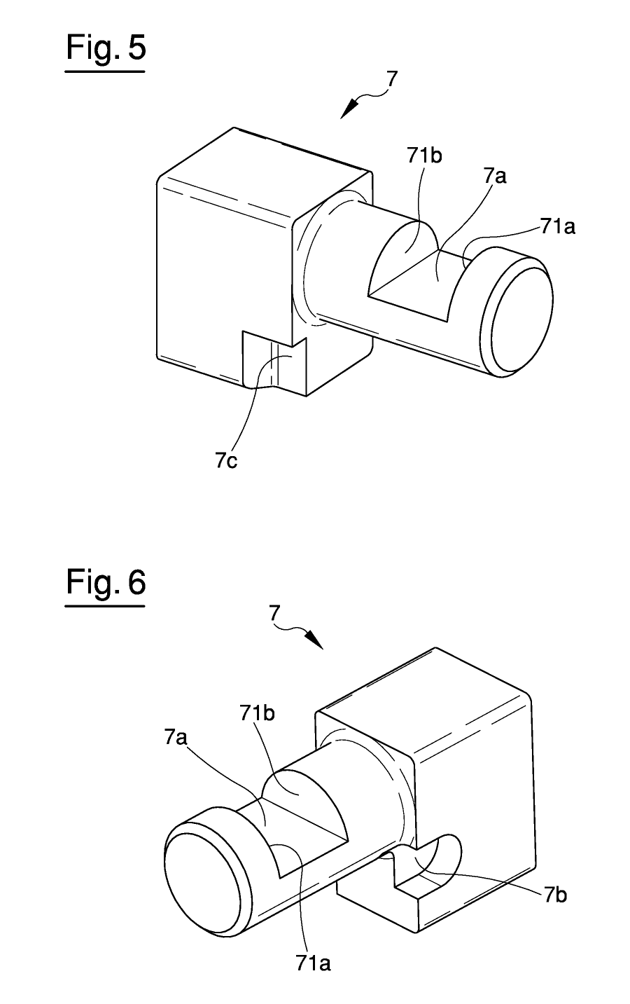

The anchoring element is preferably electromechanical and comprises an anchor 8 activated to run, by means of a solenoid 9, from an external position, in which it engages the cursor 7 to prevent the cursor 7 from following the bolt 6 in the second tract of run from the closed position to the open position, to an internal position, in which it does not engage to the cursor 7, which is free to follow the bolt 6 in the second tract of run. Elastic means 18 are predisposed to push the anchor 8 from the internal position towards the external position. The anchor 8, in the external position, is arranged with an end portion internally of a second seating 7b of the cursor 7 (FIGS. 2a and 3).

The solenoid 9 is supplied via a circuit. The circuit comprises a microswitch 10, provided with an activating button 10a which is predisposed to close during the first tract of run of the bolt 6 from the closed position to the open position. To this end the cursor 7 comprises a third seating 7c, predisposed to receive an end portion of the activating button of the microswitch 10. The closing of the microswitch 10 enables supply to the circuit by a source which is not illustrated.

A control element 11 is electrically connected to the solenoid 9. The control element 11 is predisposed to enable electrical supply to the solenoid 9 following verification of a plurality of conditions. The control device 11 can advantageously be connected to a plurality of sensors from which it receives corresponding signals relating to the conditions to be verified before enabling electrical supply to the solenoid 9 and thus the opening of the lid 4. The sensors and the corresponding signals can indicate for example when the motor cycle is not moving, when it is in a not-excessively-inclined position, or a condition in which the motor is switched off, and others besides. If all these set conditions are verified, supply to the solenoid 9 is enabled and the lid 4 can be rotated into the open position.

The functioning of the cap is now described.

Starting from an initial configuration which is illustrated in FIG. 2, in which the manoeuvring lever 5 is in the closed position, the bolt 6 is in the closed position and the anchor 8 in the external position, the user can rotate the manoeuvring lever 5 from the closed position towards the open position (FIG. 2b). The bolt 6 is drawn from the closed position towards the open position by the second end 5b of the manoeuvring lever 5 which is engaged with the first appendage 6a of the bolt 6. The first tract of run of the bolt 6 takes place freely, and thus so does a first angle of rotation of the manoeuvring lever 5. The free first tract of run of the bolt 6 terminates when the second appendage 6b thereof is arranged abutting against a first abutment 71 a of the first seating 7a of the cursor 7 (FIG. 2b). At this point, the cursor 7 for a brief tract follows the run of the bolt 6, pressing the activating button 10a of the microswitch 10 via the third seating 7c. The closing of the microswitch 10 sets off the electrical supply of the solenoid 9 supply circuit. The control element 11 at this point verifies the conditions, such as for example the motor-off condition and the motor-cycle halted condition, as well as the non-excessive tilting position of the motor cycle. If these conditions are satisfied, the control element 11 enables supply to the solenoid 9 so that the anchor 8 slides from the external position (FIGS. 2a and 3), in which it prevents the cursor 7 from following the bolt 6 which cannot thus perform the second tract of its run in order to move into the open position, to the internal position (FIG. 2c), in which the end portion of the anchor 8 disengages from the second seating 7b of the cursor 7 which is free to follow the bolt 6 in the second tract of the run thereof, so that the bolt 6 can move into the open position (FIG. 2c). As is clearly deducible from FIG. 2c, the bolt 6 and the manoeuvring lever 5 are solidly constrained to the lid 4 in the rotations thereof about the axis B, while the cursor 7, the anchor 8 and the solenoid 9 are solidly constrained to the annular body 2.

Elastic means 7d are predisposed to push the cursor 7 in the direction of the run of the bolt 6 from the closed position to the open position of the bolt 6. The function of the elastic means 7d of the cursor 7 is to maintain the cursor 7 into the position assumed at the open position of the bolt 6, i.e. in the position illustrated in FIG. 2c. This is important to enable reclosing of the lid 4.

From the configuration illustrated in FIG. 2c, the manoeuvring lever 5 can be released such that it moves into the closed position illustrated in FIG. 2a. Consequently the bolt 6 too is in the closed position. At this point the lid 4 can be rotated towards the closed position. At a certain point of the rotation of the lid 4, the end 16 of the bolt 6 enters into contact with an inclined surface 21 of the annular body 2. The contact between the end 16 of the bolt 6 and the inclined surface of the annular body 2 pushes the bolt 6 towards the open position, such that the end 16 of the bolt 6 can overcome the undercut 22. After passing over the undercut 22 the elastic means 6c push the bolt 6 into the closed position. The sliding of the bolt 6 during the passing-over of the undercut 22 is made possible without fear of obstacle by the position maintained by the cursor 7 by effect of the thrust exerted by the elastic means 7d. The thrust exerted by the elastic means 7d of the cursor 7 is however less than the thrust exerted by the elastic means 6c of the bolt 6, such that the cursor 7 is pushed into the initial position of FIG. 2 by the bolt 6. In the initial position, the cursor 7 is arranged such that the end of the anchor 8 can engage in the second seating 7b of the cursor 7, thus re-establishing the initial configuration of the cap.

The cap of the present invention provides important advantages.

It enables a considerable improvement in comfort of use of the cap, as it does not require use of a key but rather a simple activation of the manoeuvring lever. The safety function which in traditional caps is performed by the key to open the lid, i.e. it requires the motor to be turned off before opening the cap lid, is performed more efficiently and completely by the cap closing device of the invention, as beyond the mere turning off of the motor other conditions of the motor cycle can be verified, such as for example the stationary situation thereof and a position of correct inclination thereof The cap is further light and compact and does not exceed the dimensions of caps of known type.

1. A cap for fuel tanks, in particular for motorcycles, comprising: an annular body, predisposed to be fixed stably on board an access opening of a tank, which access opening delimits a through-opening through which the tank can be accessed; a lid, constrained rotatably to the annular body, which is rotatable between an open position, in which the through-opening can be accessed, and a closed position, in which the through-opening cannot be accessed; a closure device, predisposed to block the lid in the closed position; wherein the closure device comprises: a manoeuvring lever, associated to the lid; a bolt, operatively associated to the manoeuvring lever, by which manoeuvring lever the bolt is activated in motion between a closed position, in which the bolt prevents rotation of the lid from the closed position to the open position, and an open position, in which the bolt allows the rotation of the lid; a blocking and unblocking device, operatively connected to the bolt, predisposed to assume, on command, an enabled configuration, in which the blocking and unblocking device enables the bolt to be arranged in the open position, and a disenabled configuration, in which the blocking and unblocking device prevents the bolt from being arranged in the open position.

2. The cap of claim 1, wherein the blocking and unblocking device comprises a cursor, associated to the bolt such as not to obstruct a first tract of a run of the bolt from the closed position to the open position, the cursor being further associated to the bolt such as to be solidly constrained to the bolt in a second tract of the run of the bolt from the closed position to the open position, such as on command to prevent or consent performance of a second tract of run of the bolt.

3. The cap of claim 2, wherein the blocking and unblocking device comprises an anchoring element, predisposed to assume an enabled configuration, in which enabled configuration the cursor can follow the bolt in the second tract of the run from the closed position to the open position, and a disenabled configuration, in which it prevents the cursor from following the bolt in the second tract of run from the closed position to the open position, such that the bolt cannot reach the open position.

4. The cap of claim 3, wherein the anchoring element is of an electromechanical type and comprises an anchor activated to slide by means of a solenoid from an external position, in which it engages to the cursor in order to prevent the cursor from following the bolt in the second tract of the run from the closed position to the open position, to an internal position, in which it does not engage to the cursor, elastic means being predisposed to push the anchor from the internal position towards the external position.

5. The cap of claim 4, wherein the blocking and unblocking device comprises a circuit for supplying the solenoid which comprises: a microswitch, predisposed to close and to enable supply of the circuit during the first tract of the run of the bolt from the closed position to the open position; a control element, electrically connected to the solenoid, predisposed to enable electrical supply to the solenoid following verification of a plurality of conditions.

6. The cap of claim 5, wherein the control device is connected to a plurality of sensors from which it receives corresponding signals indicating conditions in which electrical supply to the solenoid can be provided.

7. The cap of claim 1, wherein the manoeuvring lever (5) comprises: a first end, on which a user can act to rotate the manoeuvring lever; a second end, facing downwards, which is predisposed for interacting with the bolt.

8. The cap of claim 7, wherein the bolt comprises: a first appendage, facing upwards and predisposed to interact with the second end of the manoeuvring lever; a second appendage, facing downwards, which is predisposed to interact with a cursor; elastic means, predisposed to push the bolt towards the closed position and to maintain the first appendage in contact with a second appendage of the manoeuvring lever.

9. The cap of claim 2, wherein the cursor comprises: a first seating, facing upwards, predisposed to receive a second appendage of the bolt; a second seating, tuned to face a first side, predisposed to receive an end portion of an anchor; a third seating, predisposed to receive an end portion of an activating button of a microswitch; elastic means, predisposed to push the cursor in a direction of the run of the bolt from the closed position to the open position.

10. The cap of claim 4, wherein the cursor comprises: a first seating, facing upwards, predisposed to receive a second appendage of the bolt; a second seating, tuned to face a first side, predisposed to receive an end portion of the anchor; a third seating, predisposed to receive an end portion of an activating button of a microswitch; elastic means, predisposed to push the cursor in a direction of the run of the bolt from the closed position to the open position, and wherein the anchor in the open position is arranged with an end portion internally of the second seating of the cursor.
